(19) United States
(12) Patent Application Publication
(10) Pub. No.: US 2021/0237716 A1
(43) Pub. Date: Aug. 5, 2021

(54) INTELLIGENT VEHICLES, CONTROL LOGIC, AND ADVANCED PARK ASSIST SYSTEMS WITH CAMERA-BASED AUTOMATED VEHICLE ALIGNMENT

(71) Applicant: GM GLOBAL TECHNOLOGY OPERATIONS LLC, Detroit, MI (US)

(72) Inventors: Rashmi Prasad, Troy, MI (US); Sai Vishnu Aluru, Commerce Township, MI (US); Chandra S. Namuduri, Troy, MI (US); Christopher A. Stanek, Lake Orion, MI (US)

(73) Assignee: GM GLOBAL TECHNOLOGY OPERATIONS LLC, Detroit, MI (US)

(21) Appl. No.: 16/780,289

(22) Filed: Feb. 3, 2020

(51) Int. Cl. B60W 30/06; B60W 10/04; B60W 10/20; B60W 50/00; B60L 53/66; B60L 53/36; B60L 53/126; H04N 5/247; G06K 9/00; H04N 5/225

(52) U.S. Cl. CPC B60W 30/06; B60W 10/04; B60W 10/20; B60W 50/00; B60L 53/66; B60R 11/04; B60L 53/126; H04N 5/247; G06K 9/00791; H04N 5/2253; B60L 53/36

(57) ABSTRACT

A method for operating an advanced park assist system of a vehicle includes a vehicle controller receiving, from front and side cameras mounted proximate front and side sections of the vehicle, real-time images of the vehicle's forward-facing and side-facing views. These images are analyzed to detect target elements present in the vehicle's forward-facing and/or side-facing views. Responsive to detecting a target element, heading control signals are transmitted to the vehicle's steering system to reposition the vehicle and thereby locate the target element at the center of the forward-facing view and at the top of the side-facing view. Speed control signals are transmitted to the vehicle's propulsion system to propel the vehicle such that the target element disappears from the side-facing view and moves to a calibrated distance from the vehicle body's front end. The control signals are modulated to align the vehicle with a target marker of the target element.

### INTRODUCTION

The present disclosure relates generally to automated control systems of motor vehicles. More specifically, aspects of this disclosure relate to intelligent park assist systems with control logic to automate vehicle alignment for electric-drive vehicle charging.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving power through an automatic or manually shifted power transmission to the vehicle's final drive system (e.g., differential, axle shafts, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid electric and full electric (“electric-drive”) vehicles, on the other hand, utilize alternative power sources to propel the vehicle and, thus, minimize or eliminate reliance on a fossil-fuel based engine for tractive power.

A full electric vehicle (FEV)—colloquially branded as an “electric car”—is a type of electric-drive vehicle configuration that altogether removes the internal combustion engine and attendant peripheral components from the powertrain system, relying solely on electric traction motors for propulsion and for supporting accessory loads. The engine assembly, fuel supply system, and exhaust system of an ICE-based vehicle are replaced with a single or multiple traction motors, a traction battery back, and battery cooling and charging hardware in an FEV. Hybrid electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, hybrid electric vehicle engines may be turned off, in whole or in part, while the vehicle is propelled by the electric motor(s).

High-voltage electrical systems govern the transfer of electricity between the traction motor(s) and a rechargeable traction battery pack (also referred to as “electric-vehicle battery”) that stores and supplies the requisite power for operating an electric-drive powertrain. A traction battery pack contains multiple stacks of battery cells that are packaged into individual battery modules and stored inside a battery pack housing. Some vehicular battery systems employ multiple independently operable, high-voltage battery packs to provide higher voltage delivery and greater system capacity through increased amp-hours. The vehicle's electric system may employ a front-end DC-to-DC power converter that is electrically connected to the vehicle's traction battery pack(s) in order to increase the voltage supply to a high-voltage main direct current (DC) bus and an electronic power inverter module (PIM). Operation and control of a multi-phase electric motor, such as permanent magnet synchronous traction motors, may be accomplished by employing the PIM to transform DC electric power to alternating current (AC) power using pulse-width modulated control signals output from a Battery Pack Control Module (BPCM).

As hybrid and electric vehicles become more prevalent, infrastructure is being developed and deployed to make day-to-day use of such vehicles feasible and convenient. Electric vehicle supply equipment (EVSE) for recharging electric-drive vehicles come in many forms, including residential electric vehicle charging stations (EVCS) purchased and operated by a vehicle owner (e.g., installed in the owner's garage), publicly accessible EVCS provisioned by public utilities or private retailers (e.g., at gas stations or municipal charging facilities), and sophisticated high-voltage, high-current charging stations used by automobile manufacturers, dealers, and service stations. Plug-in hybrid and electric vehicles originally equipped with an onboard traction battery pack, for example, can be recharged by physically connecting a charging cable of the EVCS to a complementary charging port of the vehicle. By comparison, wireless electric vehicle charging systems (WEVCS) utilize electromagnetic field (EMF) induction or other suitable wireless power transfer (WPT) techniques to provide vehicle charging capabilities without the need for charging cables and cable ports. It is axiomatic that large-scale vehicle electrification in turn necessitates a concomitant buildout of readily accessible charging infrastructure to support daily vehicle use in both urban and rural scenarios, for both short-distance and long-distance vehicle range.

### SUMMARY

Presented herein are intelligent vehicle systems with attendant control logic for camera-based automated vehicle alignment, methods for making and methods for using such systems, and electric-drive vehicles equipped with advanced park assist (APA) systems using vision-based alignment for optimized wireless vehicle charging. By way of example, disclosed APA system architectures include vehicle-mounted, high-definition (HD) cameras that operate independently or, if desired, in conjunction with a subset or combination of other vehicle sensors and infrastructure-based cameras for acquiring real-time perspective view data of the vehicle's surroundings and driving surface. An in-vehicle Global Positioning System (GPS) transceiver may retrieve GPS coordinate data of real-time locations for the vehicle and a target element, such as an EMF wireless charging pad. In addition, a resident short-range communications component connects with a WEVCS to ascertain charge station availability and compatibility, adopt charging and communication protocols, and select service, alignment, and pairing settings. A dedicated or shared vehicle controller derives path plan data for maneuvering the vehicle to, and concomitantly aligning predetermined vehicle segments with, target marker(s) of the target element. Using the foregoing information, the vehicle controller or a distributed network of control modules or subsystem controllers govern vehicle speed, heading, and travel distance via the vehicle's propulsion system, steering system, and braking system in a closed-loop control scheme to achieve a desired alignment within a predetermined accuracy.

Attendant benefits for at least some of the disclosed concepts include novel APA system architectures that enable accurate alignment of a predetermined point, edge, and/or section of a vehicle with a target element external to the vehicle. Depending on hardware availability and processing capacity, the APA system may achieve a camera-based target positioning accuracy of between about ±3 mm to about ±8 mm in fore-aft (longitudinal) and port-starboard (lateral) alignment. The vision-based APA system is able to monitor for, identify, and ascertain precise location, shape, and size data of unique target elements. For wireless charging applications, disclosed systems, methods and devices help to optimize charging efficiency while maintaining high levels of overall system robustness. Disclosed APA systems eliminate the need for dedicated sensors, cameras, and hardware accelerators for accurate vehicle alignment during automated park-assist operations.

Aspects of this disclosure are directed to intelligent park assist systems (iPAS) with attendant control logic for camera-based automated vehicle alignment, e.g., for optimized wireless vehicle charging. In an example, there is presented a vehicle APA system that includes a front camera that mounts to the vehicle body proximate a front end thereof, one or more side cameras that each mounts proximate a respective lateral side of the vehicle body, and an optional underbody camera that mounts proximate the vehicle body's undercarriage. The front camera is operable to capture real-time, forward-facing (anterior) views of the vehicle, while each side camera is operable to capture real-time, side-facing (left/right lateral) views of the vehicle, and the underbody camera is operable to capture real-time, downward-facing (underside) views. The APA system employs a resident or remote vehicle controller that is communicatively connected to the cameras to receive therefrom camera-generated signals indicative of real-time images of the vehicle's forward-facing, side-facing, and (optionally) downward-facing views. The controller analyzes the real-time images to detect target elements present in any or all of these vehicle views. Responsive to detecting a target element, the vehicle controller transmits heading control signals to the vehicle's steering system to reposition the motor vehicle and thereby locate the target element at a center position within the forward-facing view, at a respective top position in each side-facing view, and (optionally) at a center position in the downward-facing view. Speed control signals are transmitted to the propulsion system to propel the motor vehicle forward such that the target element disappears from the side-facing view(s) and repositions to a calibrated distance from the front end of the vehicle body. Heading, braking, and speed control signals are systematically modulated to align a designated segment of the motor vehicle with a target marker of the target element.

Additional aspects of this disclosure are directed to vehicles equipped with intelligent vehicle systems that provision camera-based automated vehicle alignment. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. For purposes of this disclosure, the terms “automated” and “autonomous” may be used synonymously and interchangeably to denote vehicles with assisted and/or fully autonomous driving capabilities, including vehicle platforms that may be classified as a Society of Automotive Engineers (SAE) Level 2, 3, 4 or 5 vehicle.

In an example, an electric-drive motor vehicle includes a vehicle body with multiple road wheels and other standard original equipment. A vehicle propulsion and powertrain system (e.g., engine and/or motor, transmission, final drive, powertrain control module (PCM), etc.), a vehicle brake system (e.g., disk/drum brakes, hydraulics, brake system control module (BSCM), etc.), a steering system (e.g., drive-by-wire framework) and a network of sensing devices (e.g., radar, LIDAR, infrared, camera, GPS, automated system control module (ASCM), etc.), are also mounted to the vehicle body. For electric-drive vehicle applications, one or more electric traction motors operate alone (e.g., for FEV powertrains) or in conjunction with an internal combustion engine assembly (e.g., for HEV powertrains) to selectively drive one or more of the road wheels to thereby propel the vehicle. Also mounted on the vehicle body is one or more rechargeable traction battery packs that selectively store and transmit electric current to power the traction motor(s). A wireless charging component, which is also mounted to the vehicle body and electrically connected to the battery pack, operably couples with a wireless charging pad of a wireless electric vehicle supply equipment (WEVSE) system to thereby generate electric current.

Continuing with the discussion of the above example, the vehicle also includes a front camera that is mounted proximate a front end of the vehicle body, a side camera mounted proximate a lateral side of the vehicle body, and a vehicle controller operatively connected to the front and side cameras and the wireless charging component. The vehicle controller is programmed to receive, from the on-body vehicle cameras, camera signals indicative of real-time images of forward-facing and side-facing views of the electric-drive vehicle, and analyze the real-time images to detect if the wireless charging pad is present in any of the recorded vehicle views. Responsive to detecting the wireless charging pad, the controller transmits heading control signals to a vehicle steering system module to reposition the vehicle and thereby locate the wireless charging pad at a center position within the vehicle's forward-facing view and at a top position within the side-facing view. The controller also transmits speed control signals to a vehicle propulsion system module to propel the motor vehicle such that the wireless charging pad disappears from the side-facing view and moves to a calibrated distance from the front end of the vehicle body (e.g., target 0″ away from vehicle bumper). The heading and speed control signals are adapted to align the front bumper of the motor vehicle with a target marker of the WEVSE system.

Also presented herein are methods for manufacturing and methods for operating any of the disclosed electric-drive vehicles, intelligent vehicle systems, and/or intelligent park assist architectures. In an example, a method is presented for operating an APA system of a motor vehicle. This representative method includes, in any order and in any combination with any of the above and below disclosed options and features: receiving, via a vehicle controller of the APA system from one or more front cameras mounted to a vehicle body of the motor vehicle proximate a front end thereof, camera signals indicative of real-time images of a forward-facing view of the motor vehicle; receiving, via the vehicle controller from one or more side cameras mounted to the vehicle body proximate one or more lateral sides thereof, camera signals indicative of real-time images of a side-facing view of the motor vehicle; analyzing, via the vehicle controller, the real-time images to detect if a target element is present in the forward-facing and/or side-facing views of the motor vehicle; responsive to detecting the target element, transmitting heading control signals to a steering system of the motor vehicle to reposition the motor vehicle and thereby locate the target element at a center position within the forward-facing view and at a top position within the side-facing view; transmitting speed control signals to a propulsion system of the motor vehicle to propel the motor vehicle such that the target element disappears from the side-facing view and repositions to a calibrated distance from the front end of the vehicle body; and modulating the heading and speed control signals to align a designated segment of the motor vehicle with a target marker of the target element.

The above summary does not represent every embodiment or every aspect of this disclosure. Rather, the foregoing summary merely provides examples of some of the novel concepts and features set forth herein. The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle equipped with both wired and wireless charging capabilities and operably coupled to a representative electric vehicle charging station in accordance with aspects of the present disclosure.

FIG. 2 is a schematic illustration of a representative advanced park assist (APA) system architecture for provisioning vision-based automated vehicle alignment in accordance with aspects of the present disclosure.

FIG. 3 presents forward-facing, side-facing, and downward-facing perspective views of a motor vehicle captured by high-definition, on-body front, left-side, right-side and underbody cameras in accordance with aspects of the present disclosure.

FIG. 4 is a flowchart illustrating a representative vision-based vehicle alignment protocol for wireless charging of an electric-drive motor vehicle, which may correspond to memory-stored instructions executed by an onboard or remote controller, control-logic circuitry, programmable electronic control unit, or other integrated circuit (IC) device or network of IC devices in accord with aspects of the disclosed concepts.

The present disclosure is amenable to various modifications and alternative forms, and some representative embodiments are shown by way of example in the drawings and will be described in detail below. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the present disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle, when the vehicle is operatively oriented on a horizontal driving surface.

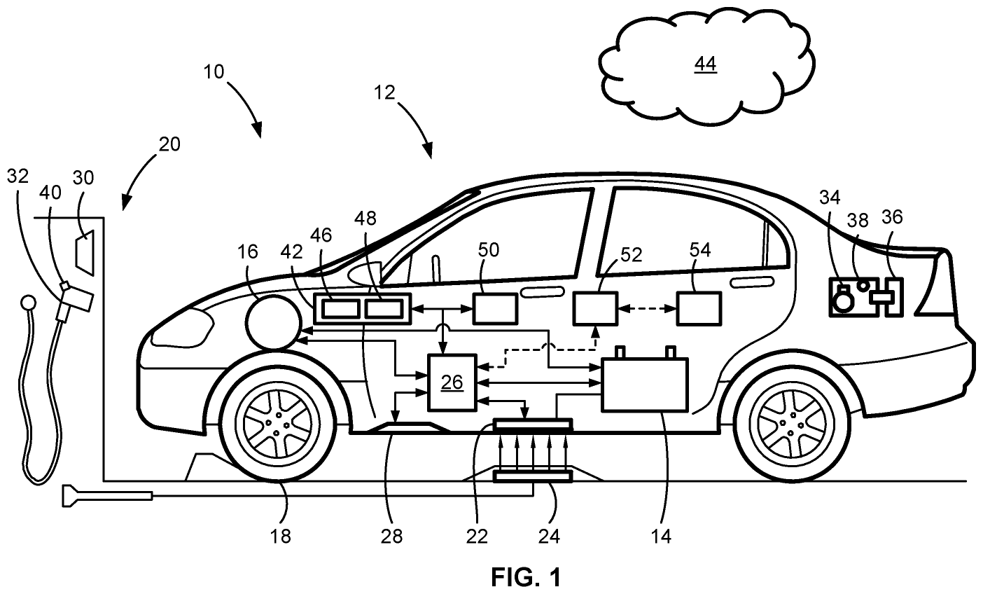

Referring now to the drawings, wherein like reference numbers refer to like features throughout the several views, there is shown in FIG. 1 a schematic illustration of a representative automobile, which is designated generally at 10 and portrayed herein for purposes of discussion as a sedan-style, electric-drive (hybrid or electric) motor vehicle. Packaged within a vehicle body 12 of the automobile 10, e.g., within a passenger compartment, trunk compartment, or dedicated battery compartment, is a traction battery pack 14 that is electrically coupled to and powers one or more electric traction motors 16. The motor(s) 16, in turn, operate to turn one or more of the vehicle's road wheels 18 and thereby propel the vehicle 10. The illustrated automobile 10—also referred to herein as “motor vehicle” or “vehicle” for short—is merely an exemplary application with which novel aspects of this disclosure may be practiced. In the same vein, implementation of the present concepts for the specific electric vehicle supply equipment (EVSE) illustrated in FIG. 1 should also be appreciated as an exemplary application of the disclosed concepts. As such, it will be understood that aspects and features of this disclosure may be applied to alternative types of EVSE, implemented for any logically relevant type of vehicle and vehicle powertrain, and utilized for other advanced driver assistance system (ADAS) operations. Moreover, only selected components of the vehicle, EVSE and APA systems have been shown and will be described in additional detail herein. Nevertheless, the systems, methods and devices discussed below can include numerous additional and alternative features, and other commercially available peripheral components, for example, to carry out the various protocols and algorithms of this disclosure.

FIG. 1 is a simplified illustration of the electric-drive vehicle 10 docked at and operably coupled to a vehicle charging station 20 for recharging an onboard rechargeable energy source, such as a high-voltage direct current (DC) traction battery pack 14. Traction battery pack 14 may take on many suitable configurations, including an array of lead-acid, lithium-ion, or other applicable type of rechargeable electric vehicle batteries (EVB). To provide an operable coupling between the traction battery pack 14 and vehicle charging station 20, the vehicle 10 may include an inductive charging component 22, e.g., with an integrated induction coil, that is mounted to the underside of the vehicle body 12. This inductive charging component 22 functions as a wireless charging interface that is compatible with a wireless charging pad or platform 24, e.g., with an internal EMF coil, of the vehicle charging station 20.

In the illustrated example, the wireless charging pad/platform 24 is located on the floor of the vehicle charging station 20, and is positioned in accordance with a “target position” that may serve as a desired parking location for purposes of efficient and effective wireless charging of the vehicle 10. In particular, FIG. 1 depicts the vehicle 10 parked in a location that helps to ensure the inductive charging component 22 is substantially or completely aligned in both lateral and longitudinal dimensions with the wireless charging pad 24. Put another way, the vehicle 10 in FIG. 1 is considered to be in proper fore-aft alignment and in proper starboard-port alignment with a designated target position to complete an inductive charging event for the vehicle 10 while maximizing the percentage of power transmitted wirelessly between the two devices.

The vehicle charging station 20 may employ any heretofore and hereafter developed type of wired and wireless charging technology, including inductive charging, radio charging, capacitive charging, and resonance charging, as some non-limiting examples. In accordance with electromagnetic induction charging technology, the representative wireless charging pad 24 of FIG. 1 may be activated with electric current to generate an alternating electromagnetic field proximate the inductive charging component 22. This magnetic field, in turn, induces an electric current in the inductive charging component 22 of the vehicle 10. The induced current may be filtered, stepped-down, and/or phase-shifted by in-vehicle electrical modulation circuitry (e.g. a traction power inverter module (TPIM)) to charge the traction battery pack 14 or any other energy source of the vehicle 10 (e.g., a standard 12V lead-acid starting, lighting, and ignition (SLI) battery, an auxiliary power module, etc.). As mentioned previously, optimal wireless charging performance may be obtained when the inductive charging component 22 is properly oriented in both fore-aft (longitudinal) and port-starboard (lateral) alignment with the wireless charging pad 24 in accordance with a vehicle-calibrated accuracy threshold.

Traction battery pack 14 stores energy that can be used for propulsion by the electric machine(s) 16 and for operating other vehicle electrical systems. The traction battery pack 14 is communicatively connected (wired or wirelessly) to one or more vehicle controllers, represented in FIG. 1 by electronic control unit (ECU) 26, that regulates the operation of various onboard vehicle systems and components. Contactors controlled by the ECU 26, for example, may isolate the traction battery pack 14 from other components when opened, and connect the traction battery pack 14 to other components when closed. The ECU 26 is also communicatively connected to the electric traction motor(s) 16 to control, for example, bi-directional transfer of energy between the traction battery pack 14 and each motor 16. For instance, traction battery pack 14 may provide a DC voltage while the motor(s) 16 may operate using a three-phase AC current; in such an instance, ECU 26 converts the DC voltage to a three-phase AC current for use by the motor-generator(s) 16. In a regenerative mode where the traction motor(s) 16 act as electric generators, the ECU 26 may convert three-phase AC current from the motor-generator(s) 16 to DC voltage compatible with the traction battery pack 14. The representative ECU 26 is also shown communicating with charging component 22, for example, to condition the power supplied from the vehicle charging station 20 to the battery pack 14 to help ensure proper voltage and current levels. The ECU 26 may also interface with the charging station 20, for example, to coordinate the delivery of power to the vehicle 10.

Vehicle charging station 20 of FIG. 1 also offers wired charging for electric vehicle 10 via a “plug-in” electrical connector 32, which may be one of a number of different commercially available electrical connector types. By way of non-limiting example, electrical connector 32 may be a Society of Automotive Engineers (SAE) J1772 (Type 1) or J1772-2009 (Type 2) electrical connector with single-phase or split-phase modes operating at 120 to 240 volts (V) with alternating current (AC) at up to 80 amperes (A) peak current for conductive vehicle charging. Furthermore, the charging connector 32 may also be designed to meet the standards set forth in International Electrotechnical Commission (IEC) 62196-2 and/or 62196-3 Fdis, as well as any other presently available or hereafter developed standards. A charge port 34 accessible on the exterior of vehicle body 12 is a wired charging interface functioning as an electrical inlet into which electrical connector 32 may be plugged or otherwise mated. This port 34 enables a user to easily connect and disconnect electric vehicle 10 to/from a readily available AC or DC source, such as a public utility power grid via charging station 20. Charge port 34 of FIG. 1 is not limited to any particular design, and may be any type of inlet, port, connection, socket, plug, etc., that enables conductive or other types of electrical connections. A hinged charge port door (CPD) 36 on vehicle body 12 can be selectively opened and closed to access and cover the charge port 34, respectively.

As part of the vehicle charging process, the vehicle 10 and station 20 may individually or collaboratively monitor wired/wireless charging availability, wireless power quality, and other related issues that may affect vehicle charging. According to the illustrated example, the vehicle ECU 26 of FIG. 1 communicates with and receives sensor signals from a monitoring system, which may comprise one or more onboard “resident” sensing devices 28 of the vehicle 10 and/or one or more off-board “remote” sensing devices 30 of the vehicle charging station 20. In practice, this monitoring system may include a single sensor, or it may include a distributed sensor architecture with an assortment of sensors packaged at similar or alternative locations to that shown in the drawings. A CPD sensor 38 mounted by the charge port 34 may sense, and be polled or read by the vehicle's ECU 26 to determine, a door status—opened or closed—of the CPD 36. As another option, a latching button 40 that helps to physically attach and secure the electrical connector 32 to the charge port 34 may include an internal switch (e.g., an SAE S3 type switch) that functions as a sensing device to detect whether or not the electrical connector 32 is operatively connected to the charge port 34. There are numerous other types of sensing devices that may also be used, including thermal sensing devices, such as passive thermal infrared sensors, optical sensing devices, such as light and laser-based sensors, acoustic sensing devices, such as surface acoustic wave (SAW) and ultrasonic sensors, capacitive sensing devices, such as capacitive-based proximity sensors, etc.

The representative vehicle 10 of FIG. 1 may be originally equipped with a vehicle telecommunication and information (“telematics”) unit 42 that wirelessly communicates (e.g., via cell towers, base stations, mobile switching centers (MSCs), etc.) with a remotely located or “off-board” cloud computing system 44. Acting as both a user-input device and a vehicle-output device, telematics unit 42 may be equipped with an electronic video display device 46 and assorted input controls 48 (e.g., buttons, knobs, switches, trackpads, keyboards, touchscreens, etc.). These telematics hardware components may function, at least in part, as a resident vehicle navigation system, e.g., to enable assisted and/or automated vehicle navigation. The telematics unit may also operate as a human-machine interface (HMI), e.g., to enable a user to communicate with the telematics unit 42 and other systems and system components of the vehicle 10. Optional peripheral hardware may include a microphone that provides a vehicle occupant with means to input verbal or other auditory commands; the vehicle 10 may be equipped with an embedded voice-processing unit programmed with a computational speech recognition software module. A vehicle audio system with one or more speaker components may provide audible output to vehicle occupants and may be either a stand-alone device dedicated for use with the telematics unit 42 or may be part of a general audio system.

With continuing reference to FIG. 1, telematics unit 42 is an onboard computing device that provides a mixture of services, both individually and through its communication with other networked devices. Telematics unit 42 may be generally composed of one or more processors, each of which may be embodied as a discrete microprocessor, an application specific integrated circuit (ASIC), a dedicated control module, etc. Vehicle 10 may offer centralized vehicle control via ECU 26 that is operatively coupled to one or more electronic memory devices 50, each of which may take on the form of a CD-ROM, magnetic disk, IC device, semiconductor memory (e.g., various types of RAM or ROM), etc., with a real-time clock (RTC). Long-range vehicle communication capabilities with remote, off-board networked devices may be provided via one or more or all of a cellular chipset/component, a navigation and location chipset/component (e.g., global positioning system (GPS) transceiver), or a wireless modem, all of which are collectively represented at 52. Close-range wireless connectivity may be provided via a short-range wireless communications device (e.g., a BLUETOOTH® unit or near field communications (NFC) transceiver), a dedicated short-range communications (DSRC) component, and/or a dual antenna, all of which are collectively represented at 54. The various communications devices described above may be configured to exchange data as part of a periodic broadcast in a Vehicle-to-Vehicle (V2V) communications system or a vehicle-to-everything (V2X) communications system, e.g., Vehicle-to-Infrastructure (V2I), Vehicle-to-Pedestrian (V2P), Vehicle-to-Device (V2D), etc.

Operation of the automobile 10 of FIG. 1 may necessitate accurate and reliable vehicle alignment with a designated position, namely precise orientation and location of a specific section of the vehicle 10, a designated component of the vehicle 10, and/or of the vehicle 10 in its entirety with a target location, orientation, object, landmark, etc. (collectively “target element” or “target”). If the target element with which the vehicle 10 is to be aligned is obstructed from the driver's view during any part of this driving operation, the requisite vehicle alignment may not be achievable. To mitigate human-borne error from such operations, disclosed intelligent vehicle systems and control logic automate precise lateral and longitudinal vehicle positioning utilizing a high-definition (HD) vision system. An HD vision system may be typified as a video camera system with a minimum of at least about a 1.0 to 2.5-megapixel (MP) full-frame resolution or, for at least some implementations, about 50-65 MP with a 4K video resolution at about 10 to 60 frames per second (fps) or greater. The HD vision system may provide a minimum horizontal field of view of at least about 160° to 210° and a minimum vertical field of view of at least about 100° to 150° with respect to a forward driving direction of the vehicle 10.

Feedback signals are analyzed to derive a coordinate distance (Cartesian in x, y, z; Celestial in φ, θ; GPS in DMS, DMM or DD) from a select point, edge, and/or section of the vehicle to a target center or other target marker of the target element. It may be desirable that the accuracy of this distance measurement be better than about 3.0 to about 8.0 millimeters (mm) at a distance of less than 1 meter (m) between the target and vehicle. Using camera-acquired data, the system is able to detect and define a target element at approximately 5.0 m or less from the camera system. Intrinsic and extrinsic camera parameters (e.g., yaw, pitch, roll, x-y-z location coordinates, etc.) may be used to identify the target, e.g., at vehicle speeds of less than approximately three (3) miles per hour (mph). Disclosed vehicle alignment systems and methods may be characterized by a lack of use of a hardware accelerator and/or partial usage of video odometer to achieve accurate vehicle alignment.

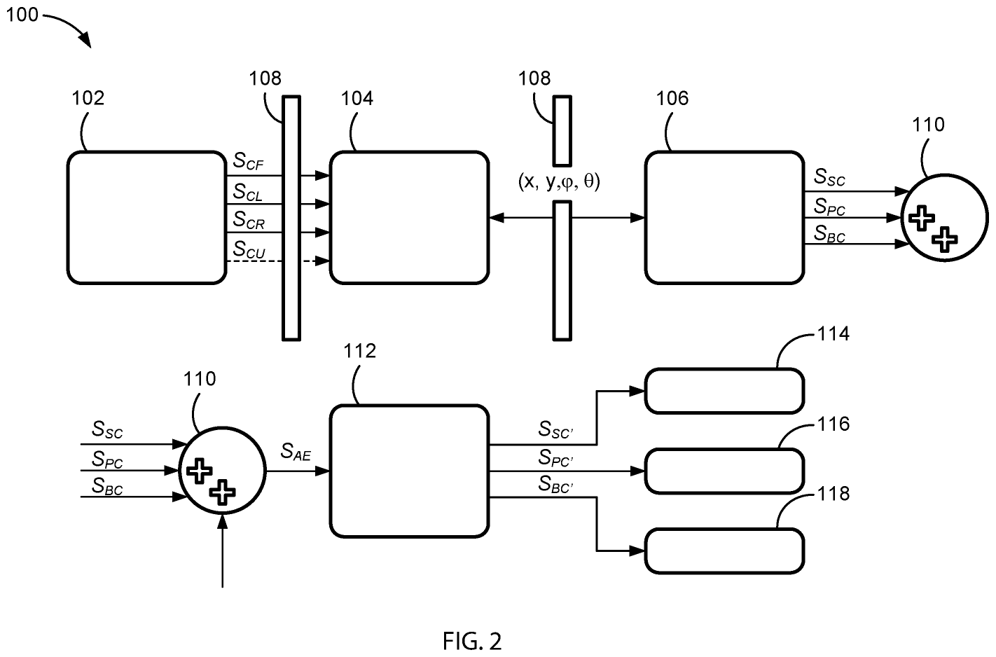

Illustrated in FIG. 2 is an embedded intelligent vehicle control system 100—described hereinbelow as an advanced park assist (APA) system—for enabling controller-automated vehicle alignment as part of select vehicle operations, such as parking, idling, charging, etc., of a motor vehicle. Intelligent vehicle system 100 is generally typified by a vision-based Camera Sensor System (CSS) 102 for capturing real-time image data of the vehicle's surroundings and driving surface, a Vision Processing System (VPS) 104 for analyzing, smoothing, fusing, and/or synthesizing camera-generated sensor signals, and a Path Planning System (PPS) 106 for calculating vehicle route data from the processed sensor signals. The CSS 102, VPS 104, and PPS 106 interface with an Automated System Control Module (ASCM) 112 to automate select vehicle driving operations, e.g., as port of a wireless charging control scheme, and with a vehicle HMI in order to transmit information to and, optionally, receive inputs from a vehicle occupant.

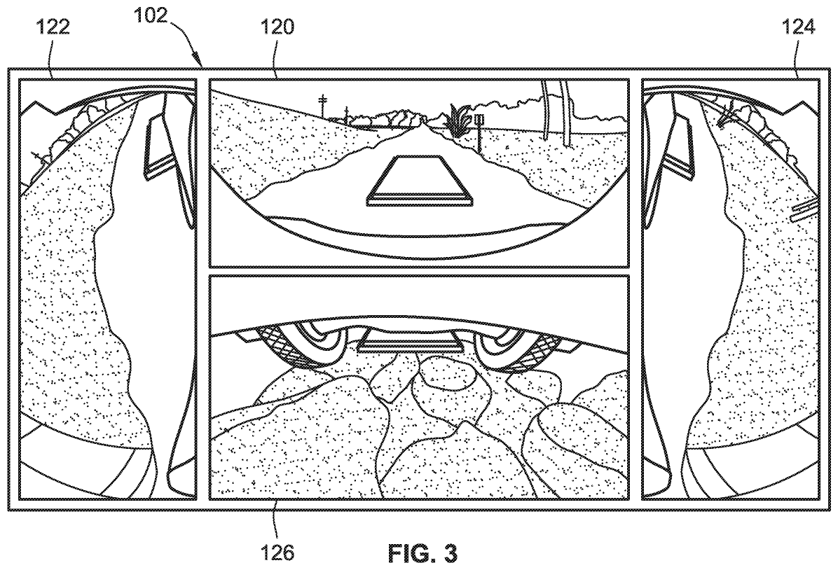

Camera Sensor System 102 may be composed of any number, type, and arrangement of image capture devices, such as a distributed array of digital video cameras each fabricated with a complementary metal-oxide-semiconductor (CMOS) sensor, charge-coupled device (CCD) sensor, or other suitable active-pixel sensor (APS). By way of non-limiting example, the CCS 102 is portrayed in FIG. 3 with: (1) a first (front) longitudinal camera 120 that mounts to the vehicle body proximate a front end thereof (e.g., inside the engine bay behind the front grille); (2) a first (left-hand) side camera 122 that mounts proximate a first lateral (port) side of the vehicle body (e.g., integrated into a driver-side rearview mirror assembly); (3) a second (right-hand) side camera 124 that mounts proximate a second lateral (starboard) side of the vehicle body (e.g., integrated into a passenger-side rearview mirror assembly); and an optional second (underbody) longitudinal camera 126 that mounts proximate the vehicle body's undercarriage (e.g., mounted to a chassis side-rail or cross-member). The type, placement, number, and interoperability of the distributed array of in-vehicle camera sensors may be adapted, singly or collectively, to a given vehicle platform for achieving a desired level of autonomous vehicle operation and alignment accuracy.

The distributed array of camera sensors 120, 122, 124 and 126 (FIG. 3) in CSS 102 communicates respective sensor signals—front, left, right, and underbody camera signals S_{CF}, S_{CL}, S_{CR}, and S_{CU}, respectively—via a controller area network (CAN) bus 108 (FIG. 2) with the VPS 104. Upon receipt, VPS 104 may comprise any requisite classification, filtering, preprocessing, fusion, and analysis hardware and software for processing received raw sensor data. VPS 104 concomitantly analyzes the processed data to determine target presence, type, and location data (x, y, φ, θ), which is then communicated to PPS 106 via CAN bus 108. As will be explained in additional detail below, PPS 106 utilizes the received target data to derive path plan data for achieving alignment with a target element, including steering system control signals S_{SC} (yaw angle and heading commands), propulsion system control signals S_{PC} (speed and acceleration commands), braking system control signals S_{BC} (stop distance and brake force commands), and any other requisite motion commands. To provision automated vehicle alignment, these control signals are fed, either directly or through a centralized ASCM 112, to a Vehicle Steering System Control Module (SSCM) 114, a vehicle Propulsion System Control Module (PSCM) 116, and Vehicle Brake System Control Module (BSCM) 118.

The motion commands output via PPS 106—controls signals S_{SC}, S_{PC}, S_{BC}—are aggregated via a summation selector module 110, along with motion feedback data as part of a closed-loop control scheme. With this closed-loop feedback, the intelligent vehicle system 100 is able to identify and quantify an alignment error, which is output as an alignment error signal SAE to ASCM 112. To offset this alignment error, the ASCM 112 may actively modulate the motion command signals, thus outputting modified steering system, propulsion system, and brake system control signals S_{SC′}, S_{PC′}, and S_{BC′}, respectively. The intelligent vehicle system 100 of FIG. 2 transmits the modified control signals S_{SC′}, S_{PC′}, and S_{BC′} to a steering actuator of the vehicle's steering system via SSCM 114, to a propulsion actuator of the vehicle's propulsion system via PSCM 116, and a brake actuator of the vehicle's brake system via BSCM 118. While illustrated as discrete control modules and subsystems, it is envisioned that any of the schematically illustrated elements of FIG. 2 may be combined into a single module/controller/system or divided into any number of networked modules/controllers/systems.

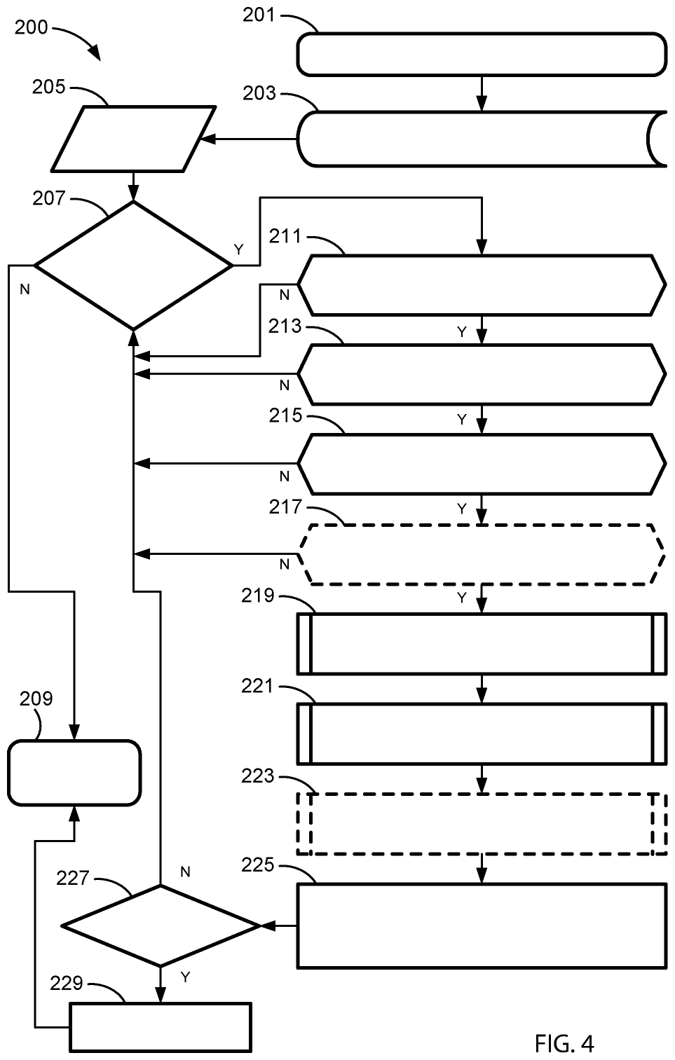

With reference now to the flowchart of FIG. 4, an improved method or control strategy for automating vehicle alignment of a motor vehicle, such as electric-drive vehicle 10 of FIG. 1, using a camera-based control system, such as intelligent vehicle system 100 of FIG. 2, is generally described at 200 in accordance with aspects of the present disclosure. Some or all of the operations illustrated in FIG. 4 and described in further detail below may be representative of an algorithm that corresponds to processor-executable instructions stored, for example, in main or auxiliary or remote memory, and executed, for example, by an on-board or remote controller, processing unit, control logic circuit, or other module, device or network of devices, to perform any or all of the above and below described functions associated with the disclosed concepts. It should be recognized that the order of execution of the illustrated operations may be changed, additional operations may be added, and some of the operations described may be modified, combined, or eliminated.

Method 200 begins at terminal block 201 with processor-executable instructions for a programmable controller or control module or similarly suitable processor or server computer to call up an initialization procedure for an automated vehicle alignment protocol. This routine may be executed in real-time, continuously, systematically, sporadically and/or at regular intervals, for example, each 100 milliseconds, etc., during ongoing vehicle operation. As yet another option, terminal block 201 may initialize responsive to a user command prompt or a broadcast prompt signal received from a backend or middleware computing node tasked with autonomous vehicle alignment. As part of the initialization procedure at block 201, for example, resident vehicle telematics unit 42 may execute a navigation processing code segment, e.g., to obtain vehicle data (e.g., geospatial data, speed, heading, acceleration, timestamp, etc.), and optionally display select aspects of this data to an occupant of the vehicle 10. The occupant may employ any of the HMI input controls 48 to then select a desired origin and/or destination for the vehicle. It is also envisioned that the ECU 26 or telematics unit 42 processors receive vehicle origin and vehicle destination information from other sources, such as a server-class computer provisioning data exchanges for the cloud computing system 44 or a dedicated mobile software application operating on a smartphone or other handheld computing device.

Upon initialization, the method 200 provides processor-executable instructions at data block 203 to acquire image data from one or more available on-body vehicle cameras. As described above, a host vehicle (e.g., automobile 10 of FIG. 1) may be originally equipped with or retrofit to include a front camera (e.g., first longitudinal camera 120 of FIG. 3) that mounts proximate a front end of the vehicle body, driver-side and/or passenger-side cameras (e.g., first and second side cameras 122, 124) that each mounts proximate a respective lateral side of the vehicle body, and an optional underbody (UB) camera (e.g., second longitudinal camera 126) that mounts proximate an undercarriage of the vehicle body. According to the illustrated example set forth in FIG. 3, the first longitudinal (front) camera 120 captures real-time, forward-facing views of the motor vehicle (e.g., an outboard field of view directed forward of the front bumper assembly), whereas the second (underbody) longitudinal camera 126 captures real-time, downward-facing views of the motor vehicle (e.g., an outboard field of view from the undercarriage directed towards the front drive axle). In the same vein, the first (left-hand) side camera 122 captures real-time, port side views of the motor vehicle (e.g., an outboard field of view oblique to a driver-side fender assembly), whereas the second (right-hand) side camera 124 captures real-time, starboard side views of the motor vehicle (e.g., an outboard field of view oblique to a passenger-side fender assembly). Each camera generates and outputs signals indicative of their respective view. These signals may be retrieved directly from the cameras or from a memory device tasked with receiving, sorting, and storing such data.

Advancing from data block 203 to input/output block 205, the method 200 of FIG. 4 scans the acquired image data for known target variants within each of the corresponding vehicle views. For instance, a resident or remote vehicle controller may analyze the real-time images to detect target elements present in the forward-facing, side-facing, and/or downward-facing views of the motor vehicle. This analysis may include scanning each image for any of multiple target elements each having a predetermined shape, size, color, outline and/or marker (collectively “target variants”). Suspected variants are isolated in and extracted from the scanned images, and a matching engine attempts to match an extracted variant with one of the predefined target variants. The target variants used for target element detection may be derived using machine learning concepts to identify individual target features corresponding to select target locations, objects, etc. The method 200 determines, at decision block 207, whether or not a target element has been detected. If not (Block 207=NO), the method 200 may advance from decision block 207 to terminal block 209 and terminate or, alternatively, may loop back to terminal block 201 and run in a continuous loop.

Responsive to detecting a target element within at least one of the perspective views of the vehicle (Block 207=YES), the method 200 of FIG. 4 proceeds to process preparation blocks 211, 213, 215 and 217 at which the detected target object is tracked by the available cameras, and vehicle movement is automated in order to reposition the target to a predetermined location within each vehicle view. According to the illustrated example, camera sensor signals are received from the front, side, and (optionally) underbody cameras; these sensor signals are indicative of real-time images of the vehicle's forward-facing, side-facing, and downward facing views. At block 211, the data images of the vehicle's forward-facing view produced by the front camera are scanned, e.g., in a continuous or substantially continuous manner, for the target; vehicle heading is concomitantly adjusted to move the vehicle and thereby locate the target at a center position within the forward-facing view. At block 213, the data images of the vehicle's leftward facing view produced by the left-side camera are scanned for the target; vehicle heading is likewise adjusted to move the vehicle and thereby locate the target at a top-right position within the leftward-facing lateral view. At block 215, the data images of the vehicle's rightward facing view produced by the right-side camera are scanned for the target; vehicle heading is adjusted to move the vehicle and thereby locate the target at a top-left position within the rightward-facing lateral view. At block 217, the data images of the vehicle's downward-facing view produced by the underbody camera are scanned for the target; vehicle heading is concurrently adjusted to move the vehicle and thereby locate the target at a center position within the downward-facing view.

If the heading control signals transmitted to the vehicle's steering system unsuccessfully locate the target at the center position within the forward-facing view (Block 211=NO), at the top-right position within the port side-facing view (Block 213=NO), at the top-left position within the starboard side-facing view (Block 215=NO), and at the center position within the downward-facing view (Block 217=NO), the method 200 loops back to decision block 207 and repeats the operations subsequent thereto. On the other hand, if proper target positioning is achieved, subroutine block 219 of FIG. 4 confirms: (1) the target element is properly positioned at the specified locations within each of the front, right, left and (optionally) underbody cameras; and (2) the target variants for the detected target extracted from the camera-generated vehicle views match the predefined target variants for a target element of that type, e.g., as retrieved from a memory-stored lookup table.

With continuing reference to FIG. 4, automated vehicle alignment method 200 advances to subroutine block 221 and executes memory-stored instructions to reposition the vehicle in a select manner to relocate the target element to new predefined locations within or outside of the various camera-captured vehicle views. In particular, the vehicle controller transmits speed control signals, heading control signals, and/or braking control signals to the vehicle's propulsion, steering, and/or braking systems to propel the motor vehicle forward such that the target element disappears from both side-facing views and repositions to a calibrated distance from the front end of the vehicle body. During a vehicle charging application, just before the target object (wireless charging pad) disappears underneath the automobile, the bumper may be located at zero (0) inches in an x-y-z Cartesian direction away from a target edge of the target object, in which case the front camera will no longer detect the target. For applications in which an underbody camera is employed, optional subroutine block 223 transmits speed, heading, and/or braking control signals to the corresponding vehicle subsystems to propel the motor vehicle forward such that the target element translates along a centerline visible in the underbody camera.

Method 200 continues from subroutine block 223 to process block 225 and commences precise alignment of the vehicle based on target element (wireless charge pad) requirements, intrinsic and extrinsic parameters of the available on-body vehicle cameras and, if used, image data produced by the underbody camera. At this time, the vehicle controller modulates heading, speed, and braking control signals to align a designated segment of the motor vehicle (e.g., inductive charging component 22) with a target marker or set of target markers (e.g., a specified point or area) of the target element (e.g., wireless charging pad 24). Extrinsic camera parameters may define a location and an orientation of a camera with respect to a uniform (world) frame (e.g., x,y,z, roll, yaw, pitch, etc.). Intrinsic camera parameters, on the other hand, may allow a mapping between camera coordinates and pixel coordinates in the image frame. At decision block 227, the method 200 determines whether or not the vehicle is aligned with the target element within a vehicle-calibrated or target-calibrated accuracy threshold (e.g., ±25 mm for full power operation of a WEVSE). If precise alignment has not yet been achieved (Block 227=NO), the method 200 loops back to decision block 207 and repeats the operations subsequent thereto.

Upon determining that a designated point, edge, component, etc. (collectively “segment”) of the motor vehicle is aligned with the target marker(s) of the target element (Block 227=YES), the method 200 responsively outputs an ALIGNMENT SUCCESSFUL signal, e.g., to the driver and/or WEVSE controller, at process block 229. Process block 229 may also include the vehicle controller transmitting a park control signal to the vehicle's propulsion/powertrain system to place the vehicle in a park state. For a wireless charging application, a wireless communications device of the vehicle, which is operable to communicate with an off-board EVCS controller, transmits a confirmation signal to the EVCS controller to verify the motor vehicle is aligned and, at the same time, to initiate vehicle charging, at process block 229.

Method 200 of FIG. 4 may include additional or alternative operations to those described above. For a wireless vehicle charging application, the vehicle may carry out a Network Discovery and Communications Setup routine: during vehicle approach at approximately 50 m from target, the vehicle or driver selects an intended wireless power transfer (WPT) parking spot; at about 30-50 m from target, the vehicle may search for a WEVSE WiFi network (service set identifier (SSID)), and retrieve vendor-specific elements (VSEs), e.g., per stored profiles; and, at about 10-30 m, the vehicle presents its credentials, attempts to authenticate, and thereafter joins the WEVSE WiFi network.

During a Service Discovery and System Compatibility Check: at about 10-30 m from target, a protocol discovery procedure commences whereat the WEVSE and vehicle agree on a communications protocol (Major/Minor version) and commence high-level communications (HLC); a service selection and initial compatibility check is performed, at which the vehicle and WEVSE exchange information about hardware compatibility, power capabilities, service selection and payment method; the vehicle selects fine positioning, pairing and alignment methods; the vehicle receives a list of available parking spot(s) after payment option is accepted by the WEVSE.

During Alignment and Pairing: at about 6-12 m from target, the intended parking spot has been identified, optional safety mechanisms may be engaged, the vehicle and EVSE may exchange configuration parameters for selected fine positioning method; the vehicle may request activation of a selected ground assembly (GA) positioning system (LPE, LF, MV); at 6-0 m from target, the vehicle and EVSE may exchange ground assembly identification (GAID) information and movement parameters; at about 2-0 m from target, the WEVSE may optionally energize the base pad; vehicle and WEVSE exchange end-movement parameters to indicate vehicle believes it is within tolerance of the GA; fine positioning and LPE engagement are confirmed and, if signal quality is deemed acceptable, charging is commenced. For some implementations, the vehicle must be parked before a “starting pairing” message is exchanged. After parking, the vehicle and WEVSE confirm coils are within tolerance as an initial assessment for pairing.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An advanced park assist (APA) system for a motor vehicle, the motor vehicle having a vehicle body with opposing front and rear ends, a steering system, and a propulsion system, the APA system comprising:
a front camera configured to mount to the vehicle body proximate the front end thereof, capture forward-facing views of the motor vehicle, and generate signals indicative thereof;
a side camera configured to mount to the vehicle body proximate a lateral side thereof, capture side-facing views of the motor vehicle, and generate signals indicative thereof; and
a vehicle controller operatively connected to the front and side cameras, the vehicle controller being programmed to:
receive, from the front camera, camera signals indicative of real-time images of a forward-facing view of the motor vehicle;
receive, from the side camera, camera signals indicative of real-time images of a side-facing view of the motor vehicle;
analyze the real-time images to detect if a target element is present in the forward-facing view and/or the side-facing view of the motor vehicle;
responsive to detecting the target element, transmit heading control signals to the steering system to reposition the motor vehicle and thereby locate the target element at a center position within the forward-facing view and at a top position within the side-facing view;
transmit speed control signals to the propulsion system to propel the motor vehicle such that the target element disappears from the side-facing view and repositions to a calibrated distance from the front end of the vehicle body; and
modulate the heading and speed control signals to align a designated segment of the motor vehicle with a target marker of the target element.

2. The APA system of claim 1, wherein the side camera includes first and second side cameras, the first side camera configured to mount to the vehicle body proximate a first lateral side thereof and capture first side-facing views of the motor vehicle, and a second side camera configured to mount to the vehicle body proximate a second lateral side thereof, opposite the first lateral side, and capture second side-facing views of the motor vehicle.

3. The APA system of claim 2, wherein the heading control signals transmitted to the steering system reposition the motor vehicle to locate the target element at a top-right position within the first side-facing view and at a top-left position within the second side-facing view.

4. The APA system of claim 3, wherein the vehicle controller is further programmed to confirm, after transmitting the heading control signals, the target element is optimally positioned, including the target element being located at the center position within the forward-facing view, at the top-right position within the first side-facing view, and at the top-left position within the second side-facing view, wherein the speed control signals are transmitted responsive to confirming the target element is optimally positioned.

5. The APA system of claim 1, further comprising an underbody camera configured to mount to the vehicle body proximate an undercarriage thereof, capture downward-facing views of the motor vehicle, and generate signals indicative thereof.

6. The APA system of claim 5, wherein the vehicle controller is further programmed to:
receive, from the underbody camera, camera signals indicative of real-time images of a downward-facing view of the motor vehicle;
analyze the real-time images to detect if the target element is present in the downward-facing view; and
responsive to detecting the target element in the downward-facing view, transmit additional heading control signals to the steering system to reposition the motor vehicle and thereby locate the target element at a center position within the downward-facing view.

7. The APA system of claim 6, wherein the vehicle controller is further programmed to transmit additional speed control signals to the propulsion system to propel the motor vehicle such that the target element translates along a centerline path within the downward-facing view.

8. The APA system of claim 1, wherein analyzing the real-time images to detect if the target element is present in the forward-facing view and/or the side-facing view includes scanning the real-time images for any of a plurality of target elements each having a predetermined shape, size, color, outline and/or marker.

9. The APA system of claim 1, wherein the vehicle controller is further programmed to:
determine if the designated segment of the motor vehicle is aligned with the target marker of the target element within a vehicle-calibrated or target-calibrated tolerance; and
responsive to the designated segment of the motor vehicle being aligned, transmit a park control signal to the propulsion system of the motor vehicle.

10. The APA system of claim 9, further comprising a wireless communications device operable to communicate with an electric vehicle supply equipment (EVCS) controller, wherein the vehicle controller is further programmed to transmit a confirmation signal to the EVCS controller via the wireless communications device verifying the motor vehicle is aligned and initiating vehicle charging.

11. The APA system of claim 10, wherein the target element is a wireless charging pad of a wireless EVCS, and wherein the vehicle controller is further programmed to receive geodetic location data for the target marker of the wireless charging pad from the EVCS controller via the wireless communications device.

12. The APA system of claim 10, wherein the vehicle controller is further programmed to receive, from the EVCS controller via the wireless communications device, station availability and compatibility data, charging protocol data, communications protocol data, and/or service, alignment, and pairing settings data.

13. The APA system of claim 1, further comprising a Global Positioning System (GPS) transceiver configured to communicate with a remote GPS satellite service, and wherein the vehicle controller is further programmed to:
receive geodetic location data for the target marker and the motor vehicle;
determine path plan data for driving the motor vehicle to target marker of the target element based on the received geodetic location data; and
determine the heading control signals and the speed control signals based, at least in part, on the determined path plan data.

14. An electric-drive vehicle, comprising:
a vehicle body with a plurality of road wheels attached to the vehicle body;
a traction motor mounted to the vehicle body and configured to drive one or more of the road wheels to thereby propel the vehicle;
a traction battery pack mounted to the vehicle body and configured to exchange an electric current with the traction motor;
a wireless charging component mounted to the vehicle body, electrically connected to the traction battery pack, and configured to operably couple with a wireless charging pad of a wireless electric vehicle supply equipment (WEVSE) system to thereby generate electric current;
a front camera mounted to the vehicle body proximate a front end thereof, the front camera being configured to capture forward-facing views of the vehicle;
a side camera mounted to the vehicle body proximate a lateral side thereof, the side camera being configured to capture side-facing views of the vehicle; and
a vehicle controller operatively connected to the front and side cameras and the wireless charging component, the vehicle controller being programmed to:
receive, from the front and side cameras, camera signals indicative of real-time images of forward-facing and side-facing views of the electric-drive vehicle;
analyze the real-time images to detect if the wireless charging pad is present in the forward-facing view and/or the side-facing view of the vehicle;
responsive to detecting the wireless charging pad, transmit heading control signals to a vehicle steering system module to reposition the vehicle and thereby locate the wireless charging pad at a center position within the forward-facing view and at a top position within the side-facing view;
transmit speed control signals to a vehicle propulsion system module to propel the motor vehicle such that the wireless charging pad disappears from the side-facing view and moves to a calibrated distance from the front end of the vehicle body; and
modulate the heading and speed control signals to align a front bumper of the motor vehicle with a target marker of the WEVSE system.

15. A method for operating an advanced park assist (APA) system of a motor vehicle, the method comprising:
receiving, via a vehicle controller of the APA system from a front camera mounted to a vehicle body of the motor vehicle proximate a front end thereof, camera signals indicative of real-time images of a forward-facing view of the motor vehicle;
receiving, via the vehicle controller from a side camera mounted to the vehicle body proximate a lateral side thereof, camera signals indicative of real-time images of a side-facing view of the motor vehicle;
analyzing, via the vehicle controller, the real-time images to detect if a target element is present in the forward-facing view and/or the side-facing view of the motor vehicle;
responsive to detecting the target element, transmitting heading control signals to a steering system of the motor vehicle to reposition the motor vehicle and thereby locate the target element at a center position within the forward-facing view and at a top position within the side-facing view;
transmitting speed control signals to a propulsion system of the motor vehicle to propel the motor vehicle such that the target element disappears from the side-facing view and repositions to a calibrated distance from the front end of the vehicle body; and
modulating the heading and speed control signals to align a designated segment of the motor vehicle with a target marker of the target element.

16. The method of claim 15, wherein receiving the camera signals from the side camera includes:
receiving first camera signals from a first side camera mount to the vehicle body proximate a first lateral side thereof, the first camera signals being indicative of real-time images of a first side-facing view of the motor vehicle; and
receiving second camera signals from a second side camera mount to the vehicle body proximate a second lateral side thereof, opposite the first lateral side, the second camera signals being indicative of real-time images of a second side-facing view of the motor vehicle distinct from the first side-facing view.

17. The method of claim 16, further comprising confirming, after transmitting the heading control signals, the target element is optimally positioned, including the target element being located at the center position within the forward-facing view, at a top-right position within the first side-facing view, and at a top-left position within the second side-facing view, wherein the speed control signals are transmitted responsive to confirming the target element is optimally positioned.

18. The method of claim 15, further comprising:
receiving, from an underbody camera mounted to the vehicle body proximate an undercarriage thereof, camera signals indicative of real-time images of a downward-facing view of the motor vehicle;
analyzing the real-time images to detect if the target element is present in the downward-facing view; and
responsive to detecting the target element in the downward-facing view, transmitting additional heading control signals to the steering system to reposition the motor vehicle and thereby locate the target element at a center position within the downward-facing view.

19. The method of claim 18, further comprising transmitting additional speed control signals to the propulsion system to propel the motor vehicle such that the target element translates along a centerline path within the downward-facing view.

20. The method of claim 15, further comprising:
determining if the designated segment of the motor vehicle is aligned with the target marker of the target element within a calibrated tolerance; and
responsive to the designated segment of the motor vehicle being aligned, transmitting a park control signal to the propulsion system of the motor vehicle.
